(19) United States
(12) Patent Application Publication
(10) Pub. No.: US 2010/0279114 A1
(43) Pub. Date: Nov. 4, 2010

(54) PREPREG MANUFACTURING METHOD AND PREPREG

(75) Inventors: Akihiko Tobisawa, Tokyo (JP); Hiroshi Obata, Tokyo (JP); Yoshiteru Urata, Tokyo (JP)

Correspondence Address: DITTHAVONG MORI & STEINER, P.C., 918 Prince Street, Alexandria, VA, 22314, US

(73) Assignee: Sumitomo Bakelite Co., Ltd., Tokyo (JP)

(21) Appl. No.: 12/514,887

(22) PCT Filed: Nov. 15, 2006
(86) PCT No.: PCT/JP2006/323256

§ 371 Date: Jul. 22, 2010

(51) Int. Cl. B05D 1/28; B05C 1/08; D02G 3/02

(52) U.S. Cl. 428/378; 427/428.02; 118/234

(57) ABSTRACT

The invention offers a method of manufacturing a prepreg capable of impregnating a fiber substrate with a liquid resin with a high degree of impregnation, and a prepreg obtained by this method. The invention is a method of manufacturing a prepreg by impregnating a long fiber substrate with a liquid resin using a kiss roller whose bottom portion is immersed in a liquid resin, including a step of impregnating the fiber substrate with a liquid resin from one surface thereof, by conveying the fiber substrate while maintaining contact with a circumferential surface of the kiss roller which is not immersed in resin, and performing this step at least twice in succession, and a prepreg obtained by this manufacturing method.

### TECHNICAL FIELD

Embodiments of the present invention relate to prepreg manufacturing methods and prepregs resulting from such methods.

### BACKGROUND

The prepregs used in the manufacture of laminates used in printed circuit boards or the like are generally obtained by impregnating a long fiber substrate (hereinafter sometimes referred to simply as “substrate”) with a liquid resin, then drying or semi-curing. The substrates may be of a cloth form, and the material may be glass fiber, polyester fiber, aramid fiber or the like. Examples of liquid resins include resin varnishes containing resins such as epoxy resins or polyimide resins blended with curing agents as needed and dissolved in an organic solvent. By impregnating such a fiber substrate with a liquid resin while continuously advancing the substrate, it is possible to continuously produce a prepreg. As a method for impregnating the substrate with a liquid resin, a dipping method of immersing the substrate in the liquid resin is common, but the dipping method is problematic in that air can be trapped inside the substrate, thus leaving unimpregnated portions (voids).

Therefore, the kiss roller method has been considered as a method for eliminating such unimpregnated portions (see, e.g., Japanese Patent Application, First Publication No S60-165213). The kiss roller method involves continuously feeding and pressing a fiber substrate against the circumferential surface of a kiss roller coated with a liquid resin, so as to impregnate the substrate by pushing resin into the substrate from a surface thereof. However, with the kiss roller method, the contact distance between the substrate and the kiss roller is short, only about 100 mm, so there is little time for the substrate to be impregnated by the liquid resin, and the impregnation effect is inadequate.

Thus, it would be advantageous to provide solutions that can be readily implemented, such solutions directed to the above-related technical problems that can occur with the known kiss roller method. It would be desirable for such solutions to provide a method for manufacturing a prepreg capable of impregnating a fiber substrate with a liquid resin with a high degree of impregnation. Further, it would be advantageous to provide prepregs obtained by such a method.

### BRIEF DESCRIPTION OF THE DRAWINGS

FIG. 1 is a schematic section view showing an impregnation step in accordance with an embodiment of the present invention;

FIG. 2 is a schematic section view showing an impregnation step in accordance with another embodiment of the present invention;

FIG. 3 is a schematic section view showing an impregnation step in accordance with Comparative Example 1; and

FIG. 4 is a schematic section view showing an impregnation step in accordance with Comparative Example 2.

### DETAILED DESCRIPTION

Exemplary embodiments of the invention will be described below. In some embodiments, a method for manufacturing a prepreg includes a method of manufacturing prepreg by impregnating a long fiber substrate or web with a liquid resin using a kiss roller, the method comprising at least two successive repetitions of the step of causing the liquid resin to adhere to a circumferential surface of the kiss roller and impregnating the fiber substrate with the liquid resin from one surface thereof, by conveying the fiber substrate while maintaining a pressure contact with the kiss roller.

In the foregoing, while there is no particular restriction on the liquid resin to which the manufacturing method of the present invention can be applied, any type that is normally used in the manufacture of laminates may be used. For example, the resins may be thermosetting resins such as epoxy resins, phenol resins or polyimide resins, and curing agents and curing promoters may be added as needed. Aside therefrom, it is also possible to blend various additives including inorganic fillers such as silica, calcium carbonate and barium sulfate, plasticizers and colorants.

Furthermore, solvents for dissolving or dispersing the above components (including ketones such as acetone, alcohols such as methanol and amides such as N,N-dimethylformamide) may be admixed to liquefy the above resins (resin compositions) to form resin varnishes that may be suitably used.

Additionally, while there is no particular restriction on the fiber substrate applied to the manufacturing method of the present invention, a sheet-type fiber substrate of woven fabric or non-woven fabric may be suitably used.

While the material of the fiber substrate is not particularly restricted, it is possible to use inorganic fibers such as glass fibers and carbon fibers, organic fibers such as polyester fibers and aramid fibers, or a mixture thereof. Additionally, the yarn forming the substrate may be monofilament yarn or multifilament yarn.

Among these, one exemplary fiber substrate is a glass fabric. As a result, it is possible to achieve high impregnation improvement effects due to the manufacturing method of the present invention, while also enabling the prepreg obtained in this way to be suitably used as a material for laminates such as a circuit board.

In some embodiments, the time of contact between the one surface of the fiber substrate and the liquid resin is a total of at least 2 seconds. In one embodiment, the time of contact between the one surface of the fiber substrate and the liquid resin is a total of at least 5 seconds. As a result, it is possible to achieve the impregnation effects strongly. If the contact time is less than 2 seconds, the friction acting on the substrate, is insufficient, so the impregnation effect is not adequate. While there is no particular limitation on the upper boundary for the contact time, it is usually preferable for it to be 30 seconds or less when taking into account the effects on productivity and equipment size.

In some embodiments, the method of manufacturing a prepreg comprises the step of preliminarily providing a reservoir for holding the liquid resin and a plurality of kiss rollers attached to the reservoir for rotation and disposed such that the bottom portion of each of the kiss rollers is immersed in the resin; and the step of bringing the fiber substrate into pressure contact with the upper portion of the circumferential surface of each of the kiss rollers in order to impregnate the fiber substrate with the liquid resin.

In a more specific embodiment, the method for manufacturing a prepreg further comprises disposing a plurality of kiss rollers in the reservoir in a generally horizontally spaced relation to one another, and further disposing an inversion roller between adjacent kiss rollers for guiding the fiber substrate towards the kiss rollers to thereby increase contact area between the fiber substrate and each of the kiss rollers.

In a further embodiment, the method for manufacturing a prepreg further comprises disposing a plurality of kiss rollers in the reservoir in vertically and horizontally spaced relation to one another so as to provide an upwardly protruding curved conveying path for the fiber substrate, and further conveying the fiber substrate along the path while maintaining pressure contact with each of the kiss rollers at upper surfaces thereof.

In the foregoing embodiments, the plurality of kiss rollers may be rotated at an identical peripheral speed. This is because there is the risk of the filaments of the substrate becoming twisted if the rollers are rotated at different speeds.

In a specific embodiment, the direction of rotation of the plurality of kiss rollers may be the same as or opposite to the direction in which the fiber substrate is conveyed. In the case where the directions are opposite, the amount of liquid resin applied to the fiber substrate may be increased.

Embodiments in accordance with the present invention also provide an apparatus for manufacturing a prepreg by impregnating a long fiber substrate with a liquid resin, the apparatus comprising at least two impregnation units disposed in succession for causing the liquid resin to adhere to a circumferential surface of a kiss roller and impregnating the fiber substrate with the liquid resin from one surface thereof, by conveying the fiber substrate while maintaining a pressure contact with the kiss roller.

Specifically, among the known kiss roller apparatuses for use in the manufacture of prepregs, there is a type wherein a plurality of kiss rollers are furnished but the impregnation steps thereby are not in succession. Such known apparatuses did not have good impregnation. In contrast, the apparatus in accordance with the above embodiments exhibits an improved impregnation.

In more specific embodiments, the apparatus comprises a reservoir for holding the liquid resin; and a plurality of kiss rollers attached to the reservoir for rotation and disposed such that a bottom portion of each of the kiss rollers is immersed in the resin in the reservoir, whereby during the conveyance of the fiber substrate with being kept in contact with a circumferential surface of each of the kiss rollers, the fiber substrate is impregnated with the liquid resin.

In some embodiments, the apparatus comprises a reservoir for holding the liquid resin; a plurality of kiss rollers attached to the reservoir for rotation and disposed such that a bottom portion of each of the kiss rollers is immersed in the resin in the reservoir; and a conveying unit for conveying the fiber substrate while rotating the plurality of kiss rollers to bring the fiber substrate into contact with the circumferential surface of each of the kiss rollers.

In a specific embodiment, the conveying unit comprises a pair of inversion rollers disposed adjacent starting and terminating ends of the kiss roller arrangement for guiding the fiber substrate against the plurality of kiss rollers. In one embodiment, the plurality of kiss rollers are disposed in the reservoir in a generally horizontally spaced relation to one another, and the conveying unit further comprises an additional roller disposed between adjacent kiss rollers for guiding the fiber substrate towards the kiss rollers to thereby increase the contact area between the fiber substrate and each of the kiss rollers.

In a further embodiment, the plurality of kiss rollers are disposed in the reservoir in a vertically and horizontally spaced relation to one another so as to provide an upwardly protruding curved conveying path for the fiber substrate, whereby the fiber substrate is conveyed along the path while maintaining pressure contact with each of the kiss rollers at upper surfaces thereof.

A yet further embodiment provides a prepreg obtainable by a manufacturing method in accordance with the aforesaid method embodiments. In this embodiment, a high degree of impregnation can be achieved as compared with conventional methods,

### Prepreg Manufacturing Apparatus and Method

Herebelow, the apparatus and method for manufacturing a prepreg in accordance with a specific embodiment of the present invention shall be explained in detail by referring to the attached drawings.

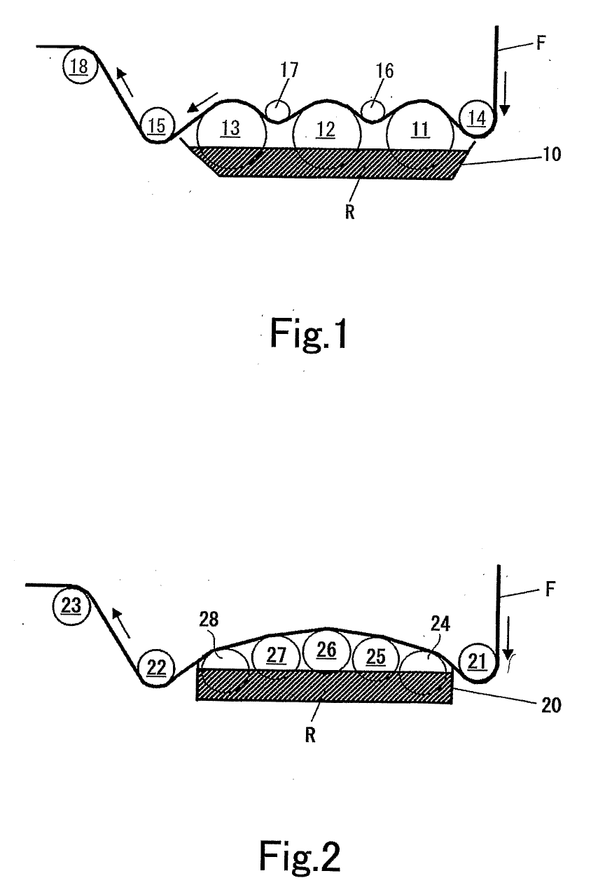

FIG. 1 is a schematic representation for a specific embodiment of a prepreg manufacturing apparatus, which includes a plurality of impregnation units, such as three units, disposed in succession for causing liquid resin R to adhere to a circumferential surface of a kiss roller and impregnating a long fiber substrate F with the liquid resin R from one surface thereof, by conveying the fiber substrate F while maintaining a pressure contact with the kiss roller. More specifically, the apparatus includes a reservoir 10 for holding liquid resin R therein; a plurality of kiss rollers, such as three kiss rollers 11, 12 and 13, disposed in a generally horizontally spaced relation to one another for rotation such that a bottom portion of each roller is immersed in the liquid resin R contained in the reservoir 10; and a conveying unit operable to convey the fiber substrate F so as to be kept in contact with a circumferential surface of each of the kiss rollers 11, 12 and 13. The liquid resin R is a resin composition as described above and having a rheological property suitably adjusted in advance. The reservoir 10 may be any type of container or pan, but may be equipped with a suitable control apparatus operable to regulate the levels and properties of the liquid resin R therein to desired conditions in order to provide a generally uniform amount of the liquid resin on the circumferential surfaces of the kiss rollers 11, 12 and 13. To be more specific, such control apparatus may include a circulating unit for causing the liquid resin R to circulate to maintain a uniform composition and properties. The level of the liquid resin in the reservoir may be controlled by controlling the supply of the liquid resin to the reservoir, or alternatively or additionally, by the adjustment of the height of the reservoir.

The conveying unit includes a pair of front and back inversion rollers 14 and 15 disposed immediately before and after the kiss roller arrangement (inversion roller 14 is located before the first kiss roller 11, whereas inversion roller 15 is located after the last kiss roller 13), in order to guide the fiber substrate F against the plurality of kiss rollers 11, 12 and 13, and additional inversion rollers 16, 17 disposed between adjacent kiss rollers for guiding the fiber substrate towards the kiss rollers 11, 12 and 13 to thereby increase the contact area between the fiber substrate F and each of the kiss rollers 11, 12 and 13. The conveying unit further includes a unit for use in continuously unwinding the fiber substrate roll, a unit for driving other driven rollers in a controlled manner and additional units such as undriven rollers including a further inversion roller 18. Thus, each kiss roller and additional equipment operably associated with a respective one of the kiss rollers constitute each of the aforesaid impregnation units.

In operation, the fiber substrate F, which is a long sheet-shaped fiber substrate in wound form, is continuously unwound and conveyed by the conveying unit onto the kiss rollers 11, 12 and 13. More specifically, the fiber substrate F is conveyed through the inversion roller 14 and is brought into contact with the circumferential surface of the kiss roller 11 by the inversion rollers 14 and 16, brought into contact with the kiss roller 12 by the inversion rollers 16 and 17, and further brought into contact with the kiss roller 13 by the inversion rollers 17 and 15. The kiss rollers 11, 12 and 13 are rotated at an identical rotational peripheral speed in the direction in which the fiber substrate F is conveyed. That is, the kiss rollers 11, 12 and 13 are rotated in a counterclockwise direction in FIG. 1. During rotation, the lower parts of the kiss rollers 11, 12 and 13 are immersed in the reservoir 10, so the liquid resin R contained in the reservoir 10 is caused to adhere to and brought upward by the circumferential surfaces of the kiss rollers 11, 12 and 13, so that as the fiber substrate F is conveyed in a pressure contact with the kiss rollers 11, 12 and 13, the liquid resin adhering to the circumferential surfaces of the kiss rollers 11, 12 and 13 is transferred to and impregnated into the fiber substrate F. As a result, the fiber substrate F is impregnated with the liquid resin R, and the fiber substrate which has been impregnated with the liquid resin R passes along the further inversion roller 18 and is conveyed to the next step.

In this embodiment, the time of contact between the one surface of the fiber substrate F and the liquid resin R is controlled to be a total of at least 2 seconds, and preferably a total of at least 5 seconds. As a result, it is possible to achieve the impregnation effects strongly.

In this specific embodiment, since the kiss rollers 11, 12 and 13 are operably disposed in succession, a sufficient impregnation can be achieved. More specifically, without being bound to any theory, one of the surfaces of the fiber substrate F is impregnated with the liquid resin R while maintaining contact with a plurality of kiss rollers 11, 12 and 13 in succession, and this enables the bottom surface of the fiber substrate F to contact the kiss roller 11, 12 or 13, so that a frictional force acts on the fiber substrate F to loosen yarns in the substrate fibers, allowing air inside the yarns to flow and be expelled through the top portion. Furthermore, by continuously supplying a liquid resin from the bottom surface of the substrate while maintaining this state, the air contained inside the substrate can be expelled from the top portion of the substrate while easily replacing the air with the liquid resin R. As a result, it is possible to improve the degree of impregnation of liquid resin into the fiber substrate. By including such an, impregnation unit or step, it is possible to manufacture a prepreg excelling in impregnation and having few voids.

In the foregoing, although the kiss rollers 11, 12 and 13 are rotated in the same direction as the conveyance direction of the fiber substrate, they may be rotated in the direction opposite to the conveyance direction of the fiber substrate F.

Additionally, in a modified embodiment, a metering mechanism for adjusting the amount of the liquid resin loaded on the circumferential surface of each kiss roller may be disposed in adjacent relation to each of the kiss rollers, and such a metering mechanism may comprise metering rollers which function to uniformly adjust the amount of the liquid resin loaded on the kiss roller.

Furthermore, in the foregoing embodiment, each kiss roller 11, 12 or 13 is disposed such that a bottom portion thereof is immersed in the liquid resin contained in the reservoir 10. However, each kiss roller may be replaced by a vertical kiss roller system comprising a pair of upper and lower kiss rollers held in rolling contact with each other, wherein only the lower kiss roller is partly immersed in the liquid resin contained in the reservoir, and as both kiss rollers are rotated in opposite directions, the upper kiss roller is brought into contact with the fiber substrate. Thus, the liquid resin loaded on the outer peripheral surface of the lower kiss roller is conveyed to the outer peripheral surface of the upper kiss roller, and then conveyed from the upper kiss roller to the fiber substrate. With the use of this two-roller system, the liquid resin conveyed to the fiber substrate can be made uniform in amount.

FIG. 2 is a schematic representation of another embodiment of a prepreg manufacturing apparatus, which is similar to the embodiment shown in FIG. 1 except for the arrangement of the kiss rollers. In FIG. 2, 20 denotes a reservoir corresponding to the reservoir 10 of FIGS. 1, and 21, 22 and 23 denote inversion rollers corresponding to the inversion rollers 14, 15 and 18 of FIG. 1. In the arrangement of FIG. 2, a plurality of kiss rollers 24 through 28 are disposed in the reservoir 20 in a vertically and horizontally spaced relation to one another so as to provide an upwardly protruding curved conveying path for the fiber substrate F, whereby the fiber substrate F is conveyed along the path while maintaining pressure contact with each of the kiss rollers 24 through 28 at upper surfaces thereof. With this construction, there is no need to furnish inversion rollers between the adjacent kiss rollers. Instead, it is necessary to adjust, the vertical positioning of the kiss rollers 24 through 28 so as to provide the aforesaid curved conveying path.

In operation, the inversion rollers 21 and 22 cause the fiber substrate F to successively contact the kiss rollers 24 through 28. The bottom portions of these kiss rollers 24 through 28 are in contact with the liquid resin R contained in the reservoir 20, so that the fiber substrate F is impregnated with the liquid resin R as the fiber substrate F is conveyed while maintaining contact with the kiss rollers 24 through 28. As a result, the substrate is impregnated with the liquid resin. The fiber substrate F which has been impregnated with the liquid resin R passes along the inversion roller 23 and is conveyed to the next step.

In this embodiment, since a plurality of the kiss rollers 24 through 28 are operably disposed in succession, a sufficient impregnation can be achieved in a manner similar to those in the previous embodiment shown in FIG. 1.

In this embodiment, a plurality of the kiss rollers 24 through 28 may be positioned in a fixed manner so as to provide an upwardly protruding curved conveying path for the fiber substrate F. However, it may also be possible to construct the kiss roller arrangement such that the height of each kiss roller is adjustable by a suitable means.

Further, in FIG. 2, only one reservoir 20 is provided for all the kiss rollers 24 through 28 disposed at different heights. However, it may be possible to provide a plurality of reservoirs disposed at different heights, such that the level of the liquid resin with respect to a respective kiss roller is set to the same relative height. Similarly, the reservoir may be constructed so as to have a plurality of compartments such that the level of the liquid resin in each compartment can be adjusted corresponding to the height of a respective kiss roller. Furthermore, in order to adjust the height of the kiss roller, a two-roller system may be partly incorporated in the mid portion of the kiss roller arrangement.

In the above method and apparatus of manufacture of the prepregs, the above-described impregnation process using kiss rollers can be one among several impregnation processes for impregnating the fiber substrate with liquid resin in the manufacture of prepregs. That is, it is also possible to provide other impregnation processes using formats different from the manufacturing method of the present invention before and/or after the impregnation process using kiss rollers according to the manufacturing method of the present invention. Examples of such impregnation processes include a dipping process in which the fiber substrate is immersed in a liquid resin, and a coating process in which the fiber substrate is coated with a liquid resin using a coater. Embodiments having such additional processes are also included in the present invention. On the other hand, the manufacturing method of the present invention may be used as the sole impregnation process.

### Prepregs

Next, the pregpreg of the present invention shall be described.

The prepreg of the present invention is obtained by the above-described manufacturing method of the present invention.

As described above, the prepreg of the present invention can be manufactured by impregnation by kiss rollers according to the manufacturing method of the present invention or after a plurality of impregnation processes including such impregnation, followed by adjustment of the amount of liquid resin impregnated into the fiber substrate and then thermal drying.

The conditions of the above-described thermal drying will differ according to the composition of the liquid resin and the amount impregnated, but may for example, be performed for 1-10 minutes at 150-190° C.

The prepreg of the present invention is suitable for use in printed circuit boards.

Specifically, a laminate can be produced by stacking one or more of the above-described prepregs; then molding under heat and pressure. Additionally, a laminate inlaid with a metallic foil can be produced by placing a metallic foil such as copper foil on one or both surfaces of one or a plurality of stacked prepregs. Then, the metallic foil on the laminate set with metallic foil can be processed by print wiring to form circuitry, thus resulting in a printed circuit board.

### EXAMPLES

Herebelow, examples of the present invention and comparative examples will be explained, but the present invention is not to be construed as being limited to these examples.

1. Preparation of Liquid Resin Composition 85 parts by weight of tetrabromobisphenol A type epoxy resin (EPICOAT 5047 of Japan Epoxy Resins, epoxy equivalent 550), 15 parts by weight of cresol novolak type epoxy resin (EPICLON 690 of Dainippon Ink and Chemicals, epoxy equivalent 210), 2.3 parts by weight of dicyandiamide and 0.1 parts by weight of 2-ethyl-4-methylimidazole were dissolved into N,N-dimethylformamide to prepare a liquid resin composition with a non-volatile part concentration of 55% by weight.

### 2. Fiber Substrates

A long glass fabric with a thickness of 0.18 mm and a width of 1000 mm (WEA-7628 of Nitto Boseki) was used.

### 3. Manufacture of Prepreg

### Example 1

The apparatus shown in FIG. 1 was used to impregnate the fiber substrate with the liquid resin composition. The specifications of the apparatus and operating conditions were as follows.

(1) Substrate Conveyance Speed: 5 m/min.

### (2) Diameter of Kiss Rollers 11, 12, 13: 300 mm

(3) Distance of Contact between Kiss Rollers 11, 12, 13 and Substrate: 150 mm each
(4) Time of Contact between Kiss Rollers 11, 12, 13 and Substrate: 5.4 seconds total

After impregnation, the substrate was thermally dried for 2 minutes in a thermal drying apparatus at 180° C., to give a prepreg with a resin composition content of 51% by weight.

### Example 2

A prepreg was manufactured using the same method as in Example 1, aside from the fact that the substrate conveyance speed was set to 9 m/min. and the total contact time between kiss rollers 11, 12 and 13 and the substrate was 3.0 seconds.

### Example 3

A fiber substrate was impregnated with a liquid resin composition by means of the apparatus shown in FIG. 2, using the same fiber substrate and liquid resin composition as Example 1. The specifications and operating conditions of the apparatus were as follows:

(1) Substrate Conveyance Speed: 4.8 m/min.

### (2) Diameter of Kiss Rollers 24, 25, 26, 27, 28: 200 mm

(3) Distance of Contact between Kiss Rollers 24, 25, 26, 27, 28 and Substrate: 80 mm each
(4) Time of Contact between Kiss Rollers 24, 25, 26, 27, 28 and Substrate: 4.8 seconds total

After impregnation, the substrate was thermally dried for 2 minutes in a thermal drying apparatus at 180° C., to give a prepreg with a resin composition content of 51% by weight.

### Comparative Example 1

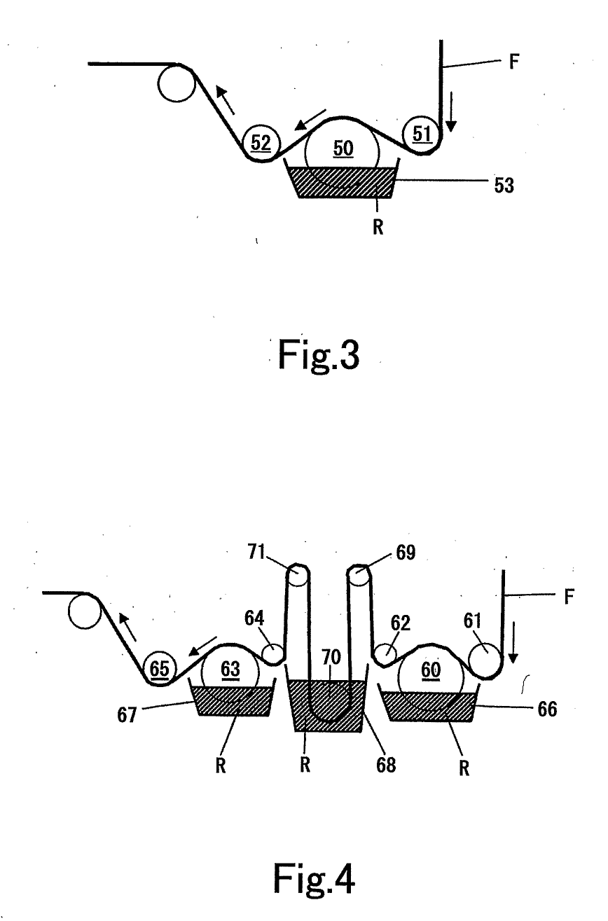

A fiber substrate was impregnated with a liquid resin composition by means of the kiss roller apparatus shown in FIG. 3, using the same fiber substrate and liquid resin composition as Example 1.

In FIG. 3, the fiber substrate F is brought into contact with the upper surface of the circumferential portion of a kiss roller 50 between roller 51 and roller 52. The bottom portion of kiss roller 50 is immersed in a liquid resin composition R contained in a reservoir apparatus 53, and rotation of kiss roller 50 causes the liquid resin composition R to contact the fiber substrate and perform impregnation.

The specifications and operating conditions of the apparatus were as follows:

### (1) Diameter of Kiss Roller 50: 200 mm

(2) Distance of Contact between Kiss Roller 50 and Substrate (in substrate conveyance direction): 100 mm

### (3) Rotational Speed of Kiss Roller 53: 10 rpm

(4) Substrate Conveyance Speed: 5 m/min.

After impregnation, a prepreg with a resin composition content of 51% by weight was obtained in the same manner as in Example 1.

### Comparative Example 2

A fiber substrate was impregnated with a liquid resin composition by means of the kiss roller apparatus shown in FIG. 4, using the same fiber substrate and liquid resin composition as Example 1.

In FIG. 4, the fiber substrate F contacts the top portion of the circumference of kiss roller 60 between roller 61 and roller 62, and also contacts the top portion of the circumference of kiss roller 63 between roller 64 and roller 65. The bottom portion of kiss roller 60 is immersed in the liquid resin composition R contained in reservoir apparatus 66, and kiss roller 63 is immersed in the liquid resin composition R contained in reservoir apparatus 67, so that the rotation of kiss rollers 60 and 63 causes the liquid resin composition R to contact and impregnate the fiber substrate F. A liquid resin composition R contained in reservoir apparatus 68 is located between kiss rollers 60 and 63, and the liquid resin composition R contained in the reservoir apparatus 68 is impregnated by a dipping method by means of rollers 69, 70 and 71.

The specifications and operating conditions of the apparatus are as follows:

### (1) Diameter of Kiss Rollers 60 and 63: 200 mm

(2) Distance of Contact between Kiss Rollers 60, 63 and Substrate (in substrates conveyance direction): 100 mm each
(3) Rotational. Speed of Kiss Rollers 60 and 63: 10 rpm each
(4) Substrate Conveyance Speed: 5 m/min.

After impregnation, a prepreg with a resin composition content of 51% by weight was obtained in the same manner as in Example 1.

After cutting the prepregs obtained in the above-described. Examples 1-3 and Comparative Examples 1-2 into 10×10 cm pieces, they were suspended for 15 minutes in a dryer at 150° C. and cooled, after which they were observed and evaluated by eye for the presence of portions not impregnated by resin. The results thus obtained are shown in Table 1.

TABLE 1

| Example or Comparative Example | Evaluation of Prepreg |
|---|---|
| Example 1 | no unimpregnated portions |
| Example 2 | no unimpregnated portions |
| Example 3 | few unimpregnated portions |
| Comparative Example 1 | unimpregnated portions |
| Comparative Example 2 | unimpregnated portions |

As can be seen in Table 1, the prepregs obtained by Examples 1-3 had few or no unimpregnated portions, and thus had good impregnation.

While Comparative Example 1 is a case where only a singe kiss roller is used in the impregnation step, the resulting prepreg had unimpregnated portions, and thus had poor impregnation.

Comparative Example 2 is a case in which there are two kiss rollers placed not in succession. The resulting prepregs had unimpregnated portions, and while the impregnation was better than that of Comparative Example 1, they were worse than Examples 1-3.

1. A method of manufacturing a prepreg by impregnating a long fiber substrate with a liquid resin using a kiss roller, said method comprising at least two successive repetitions of the step of causing the liquid resin to adhere to a circumferential surface of said kiss roller and impregnating said fiber substrate with the liquid resin from one surface thereof, by conveying said fiber substrate while maintaining a pressure contact with said kiss roller.

2. The method of manufacturing a prepreg according to claim 1, wherein the time of contact between the one surface of said fiber substrate and said liquid resin is a total of at least 2 seconds.

3. The method of manufacturing a prepreg according to claim 2, wherein the time of contact between the one surface of said fiber substrate and said liquid resin is a total of at least 5 seconds.

4. The method of manufacturing a prepreg according to claim 1, wherein said fiber substrate is a glass fabric.

5. The method of manufacturing a prepreg according to claim 1, further comprising the step of preliminarily providing a reservoir for holding the liquid resin and a plurality of kiss rollers attached to said reservoir for rotation and disposed such that the bottom portion of each of said kiss rollers is immersed in the resin; and the step of bringing said fiber substrate into pressure contact with the upper portion of the circumferential surface of each of said kiss rollers in order to impregnate said fiber substrate with the liquid resin.

6. The method for manufacturing a prepreg according to claim 5, further comprising disposing a plurality of said kiss rollers in said reservoir in a generally horizontally spaced relation to one another, and disposing an inversion roller between adjacent kiss rollers for guiding said fiber substrate towards said kiss rollers to thereby increase contact area between said fiber substrate and each of said kiss rollers.

7. The method for manufacturing a prepreg according to claim 5, further comprising disposing a plurality of said kiss rollers in said reservoir in a vertically and horizontally spaced relation to one another so as to provide an upwardly protruding curved conveying path for said fiber substrate, and conveying said fiber substrate along said path while maintaining pressure contact with each of said kiss rollers at upper surfaces thereof.

8. The method for manufacturing a prepreg according to claim 5, further comprising rotating a plurality of said kiss rollers at an identical peripheral speed.

9. An apparatus for manufacturing a prepreg by impregnating a long fiber substrate with a liquid resin, said apparatus comprising at least two impregnation units disposed in succession for causing the liquid resin to adhere to a circumferential surface of a kiss roller and impregnating said fiber substrate with the liquid resin from one surface thereof, by conveying said fiber substrate while maintaining a pressure contact with said kiss roller.

10. The apparatus according to claim 9, further comprising a reservoir for holding the liquid resin; and a plurality of kiss rollers attached to said reservoir for rotation and disposed such that a bottom portion of each of said kiss rollers is immersed in the liquid resin in said reservoir, whereby during the conveyance of the fiber substrate while being kept in contact with the circumferential surface of each of said kiss rollers, the fiber substrate is impregnated with the liquid resin.

11. The apparatus according to claim 9, further comprising a reservoir for holding the liquid resin; a plurality of kiss rollers attached to said reservoir for rotation and disposed such that a bottom portion of each of said kiss rollers is immersed in the liquid resin in said reservoir; and a conveying unit for conveying the fiber substrate while rotating said plurality of kiss rollers to bring the fiber substrate into contact with the circumferential surface of each of said kiss rollers.

12. The apparatus according to claim 11, wherein said conveying unit comprises a pair of inversion rollers disposed adjacent starting and terminating ends of the plurality of kiss rollers for guiding the fiber substrate against said plurality of kiss rollers.

13. The apparatus according to claim 12, wherein said plurality of kiss rollers are disposed in said reservoir in a generally horizontally spaced relation to one another, and wherein said conveying unit further comprises an additional inversion roller disposed between adjacent kiss rollers for guiding the fiber substrate towards the kiss rollers to thereby increase the contact area between the fiber substrate and each of said kiss rollers.

14. The apparatus according to claim 12, wherein said plurality of kiss rollers are disposed in said reservoir in a vertically spaced relation to one another so as to provide an upwardly protruding curved conveying path for said fiber substrate, whereby said fiber substrate is conveyed along said path while maintaining pressure contact with each of said kiss rollers at upper surfaces thereof.

15. A prepreg obtainable by a manufacturing method in accordance with claim 1.
